(19) United States
(12) Patent Application Publication
(10) Pub. No.: US 2017/0180614 A1
(43) Pub. Date: Jun. 22, 2017

(54) IRIS IMAGING

(71) Applicant: Intel Corporation, Santa Clara, CA (US)

(72) Inventor: Mikko Ollila, Tampere (FI)

(73) Assignee: Intel Corporation, Santa Clara, CA (US)

(21) Appl. No.: 14/972,197

(22) Filed: Dec. 17, 2015

(51) Int. Cl. H04N 5/225; G02B 26/00; G02F 1/13; G06K 9/46; G06K 9/62

(52) U.S. Cl. CPC H04N 5/2256; G06K 9/46; H04N 5/2254; G06K 9/6201; G02F 1/1313; G02B 26/001

(57) ABSTRACT

Techniques for imaging an iris are described. An example of an electronic device includes a camera and a Light Emitting Diode (LED) assembly to provide light for an iris image. The LED assembly comprises an LED and a tunable filter disposed over the LED. The tunable filter tunes the wavelength of the light emitted by the LED assembly.

### TECHNICAL FIELD

The present disclosure relates generally to techniques for imaging an iris using near infrared light. More specifically, the present techniques relate to imaging an iris using a liquid crystal film to filter the near infrared light.

### BACKGROUND ART

Iris imaging is a method of biometric identification based on the unique pattern of a person's iris. An iris image is obtained using light in the near infrared region of the electromagnetic spectrum. Near infrared light is used because it provides better images than visible light, especially when dark brown irises are imaged. The majority of people worldwide have dark brown irises which reveal little texture in visible light but appear highly textured in near infrared light.

### BRIEF DESCRIPTION OF THE DRAWINGS

FIG. 1 is a block diagram of an electronic device for imaging an iris.

FIG. 2 is an illustration of a near infrared light emitting diode assembly that includes a liquid crystal film.

FIG. 3 is an illustration of an alternative embodiment for tuning near infrared light.

FIG. 4 is a process flow diagram of a method for imaging an iris.

FIG. 5 is a block diagram showing a medium that contains logic for obtaining an iris image.

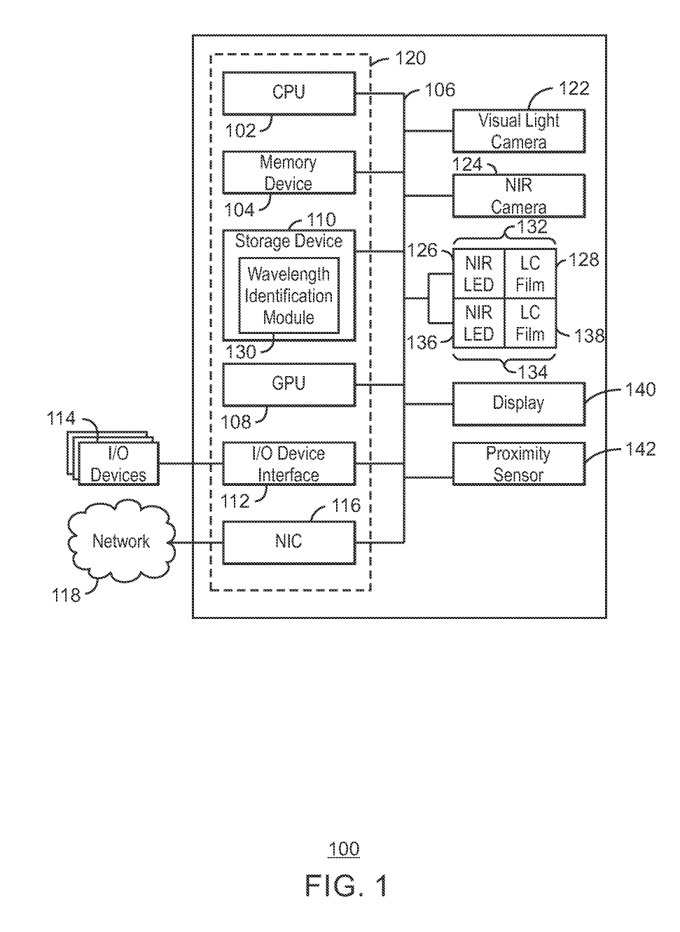

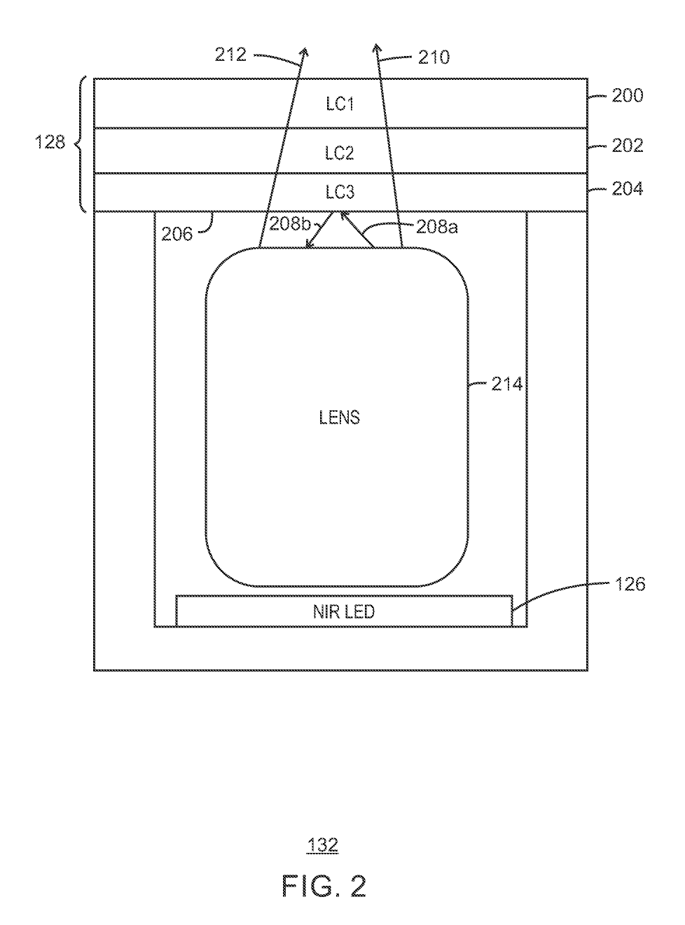

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The subject matter disclosed herein relates to techniques for imaging an iris using near infrared light. The present disclosure describes techniques for imaging an iris by tuning the wavelength of the near infrared light used to capture the iris image. For example, a first image of an iris may be obtained using a first wavelength of near infrared light. A liquid crystal film may be tuned to transmit a second wavelength and a second iris image may be obtained. The first iris image and the second iris image may be compared and the sharper of the two images may be selected. The liquid crystal film may be tuned to transmit a third wavelength and a third iris image may be obtained. The third iris image may be compared to the sharper of the first and second iris images and the sharper image may be selected. This process may repeat itself until the sharpest iris image is obtained. The wavelength that produced the sharpest image may be identified. The identified wavelength may be used to log a user into an electronic device. Various examples of the present techniques are described further below with reference to the Figures.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

FIG. 1 is a block diagram of an electronic device for imaging an iris that uses a liquid crystal (LC) film to tune the wavelength of near infrared light. For example, the electronic device 100 may be a laptop computer, tablet computer, mobile phone, smart phone, or any other suitable electronic device. The electronic device 100 may include a central processing unit (CPU) 102 that is configured to execute stored instructions, as well as a memory device 104 that stores instructions that are executable by the CPU 102. The CPU 102 may be coupled to the memory device 104 by a bus 106. The CPU 102 may be a single core processor, a multi-core processor, a computing cluster, or any number of other configurations. The CPU 102 may be implemented as a Complex Instruction Set Computer (CISC) processor, a Reduced Instruction Set Computer (RISC) processor, x86 Instruction set compatible processor, or any other microprocessor or central processing unit (CPU). In some embodiments, the CPU 102 includes dual-core processor(s), dual-core mobile processor(s), or the like.

The memory device 104 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory system. The memory device 104 can be used to store data and computer-readable instructions that, when executed by the CPU 102, direct the CPU 102 to perform various operations in accordance with embodiments described herein.

The electronic device 100 may also include a graphics processing unit (GPU) 108. As shown, the CPU 100 may be coupled to the GPU 108 via the bus 106. The GPU 108 may be configured to perform any number of graphics operations. For example, the GPU 108 may be configured to render or manipulate iris images.

The electronic device 100 may also include a storage device 110. The storage device 110 is a physical memory device such as a hard drive, an optical drive, a flash drive, an array of drives, or any combinations thereof. The storage device 110 may store data such as iris images, among other types of data. The storage device 110 may also store programming code such as device drivers, software applications, operating systems, and the like. The programming code stored by the storage device 110 may be executed by the CPU 102, GPU 108, or any other processors that may be included in the electronic device 100.

The electronic device 100 may also include an input/output (I/O) device interface 112 configured to connect the electronic device 100 to one or more I/O devices 114. For example, the I/O devices 114 may include a printer, a scanner, a keyboard, and a pointing device such as a mouse, touchpad, or, touchscreen, among others. The I/O devices 114 may be built-in components of the electronic device 100, or may be devices that are externally connected to the electronic device 100.

The electronic device 100 may also include a network interface controller (NIC) 116 configured to connect the electronic device 100 to a network 118. The network 118 may be a wide area network (WAN), local area network (LAN), or the Internet, among others.

In some embodiments, the CPU 102, the memory device 104, the storage device 110, the GPU 108, the I/O device interface 112, and the NIC 116 may be integrated as a System-On-a-Chip (SOC) 120. In other embodiments, some of the components may be integrated on a single chip, while other components may be stand-alone.

The electronic device may include a visual light camera 122 and a near infrared (NIR) camera 124. The visual light camera 122 may capture images and video using light in the visible light spectrum. The NIR camera 124 may capture images using light in the near infrared spectrum. For example, the NIR camera 124 may be used to obtain iris images.

A near infrared light emitting diode (NIR LED) 126 may provide near infrared light to illuminate the iris so that the NIR camera 124 may capture an image of the iris. A tunable liquid crystal (LC) film 128 may be associated with the NIR LED 126. The LC film 128 may filter the NIR light emitted by the NIR LED 126 so that only a very narrow band of NIR light reaches the iris. For example, the band of NIR light may be 2-5 nm wide.

The NIR camera 124 may capture a first image of the iris using the very narrow band of NIR light. The LC film 128 may change the wavelength of the NIR light emitted by the NIR LED 126 and the NIR camera 124 may capture a second image of the iris.

The electronic device 100 may include a wavelength identification module 130. The wavelength identification module 130 may compare the sharpness of the first iris image and the second iris image and may select the iris image with the better sharpness. The wavelength identification module 130 may also identify the wavelength of the near infrared light used to obtain the selected image. The process implemented via the wavelength identification module 130 may repeat itself until the wavelength of the near infrared light producing the sharpest iris image is identified.

The NIR LED 126 and the LC film 128 may be a part of an NIR LED assembly 132. The NIR LED assembly 132 is discussed in more detail below with respect to FIG. 2. The electronic device 100 may contain a second NIR LED assembly 134 composed of NIR LED 136 and LC film 138. The second NIR LED assembly 134 may function similarly to the NIR LED assembly 132. One advantage of having two NIR LED assemblies 132, 134 is that iris images can be obtained over a broader bandwidth, i.e., a larger portion of the NIR spectrum. By filtering a broader bandwidth of NIR light, two NIR assemblies may ensure that an iris image is obtained at the wavelength that produces the sharpest image of the iris.

In some embodiments, the two LC films 128 and 138 may not be used. Without the LC films 128 and 138, the two NIR LEDs 126 and 136 are still capable of producing several wavelengths of light. NIR LED 126 by itself produces light of a certain wavelength and NIR LED 136 by itself produces light of another wavelength. A third wavelength of light may be produced when light from the two NIR LEDs 126 and 136 is combined.

The electronic device 100 may further include a display 140 and a proximity sensor 142. The display 140 may present images and video captured by the visual light camera 122 and the near infrared camera 124. The proximity sensor 142 may detect how close the electronic device 100 is to a user's eye and may turn off the NIR LEDs 126, 136 when the electronic device 100 is too close to the user's eye.

Communication between various components of the electronic device 100 may be accomplished via one or more busses 106. At least one of the busses 106 may be a D-PHY bus, a Mobile Industry Processor Interface (MIPI) D-PHY bus or C-PHY bus, or an M-PHY bus, or any other suitable bus. In alternate embodiments, an interface may be used to facilitate communication between various components of the electronic device 100. Example interfaces include MIPI CCI, IC3, and the like.

The bus architecture shown in FIG. 1 is just one example of a bus architecture that may be used with the techniques disclosed herein. In some examples, the bus 106 may be a single bus that couples all of the components of the electronic device 100 according to a particular communication protocol. Furthermore, the electronic device 100 may also include any suitable number of busses 106 of varying types, which may use different communication protocols to couple specific components of the computing device according to the design considerations of a particular implementation.

The block diagram of FIG. 1 is not intended to indicate that the computing device 100 is to include all of the components shown in FIG. 1. Rather, the computing system 100 can include fewer or additional components not shown in FIG. 1, depending on the details of the specific implementation. Furthermore, any of the functionalities of the CPU 102 or the graphics processor 108 may be partially, or entirely, implemented in hardware and/or a processor. For example, the functionality may be implemented in any combination of Application Specific Integrated Circuits (ASICs), Field Programmable Gate Arrays (FPGAs), logic circuits, and the like. In addition, embodiments of the present techniques can be implemented in any suitable electronic device, including ultra-compact form factor devices, such as System-On-a-Chip (SOC), and multi-chip modules.

FIG. 2 is an illustration of the NIR LED assembly 132 which may emit a very narrow band of NIR light. As shown in FIG. 2, the NIR LED assembly 132 may be composed of an NIR LED 126 and an LC film 128. The LC film 128 may be made up of three LC layers, LC1 200, LC2 202, and LC3 204 and a supporting substrate 206. LC1 200, LC2 202, and LC3 204 filter the light emitted by the NIR LED 126 so that a selected range of wavelengths of NIR light reaches a user's eye. The substrate 206 may have an anti-reflective coating, among other coatings.

A thin LC layer (approximately 5 μm thick) can be made reflective for certain wavelengths and transmissive for other wavelengths by selecting an excitation frequency and a voltage to be applied to the LC layer. The LC material, the crystal alignment, and the thickness of the layer also affect the bandwidths that are reflected and transmitted. In embodiments of the present techniques, a single LC layer may be used to filter NIR light by changing the excitation frequency and the voltage applied to the layer. In other embodiments, such as that shown in FIG. 2, a number of LC layers 200, 202, 204 may be used. Each layer is responsive to a certain band of NIR light so that certain wavelengths are reflected 208a, 208b and other wavelengths are transmitted 210, 212. The different layers 200, 202, 204 are activated or deactivated to tune the NIR light emitted by the NIR LED 126. The transmitted wavelengths 210, 212 reach the user's eye to illuminate the iris so that an image of the iris can be obtained. The wavelength of the transmitted NIR light is determined by the reflective properties of the LC layer(s). Hence, the LC layer(s) may be referred to as an LC reflector.

LC layers have a polarizing effect. As a result, the reflectance of the NIR light is only in one direction of polarization and only half of the impingent light is reflected. In some embodiments, another LC layer with a perpendicular polarization may be added to provide 100% reflectivity. In other embodiments, each LC layer may have two components, one for each polarization direction. For example, within one layer, there may be a component for vertical polarization and a component for horizontal polarization. With 100% reflectivity of certain wavelengths, other wavelengths are transmitted by the LC layer and reach the user's eye.

In some embodiments, such as that shown in FIG. 2, there may be a lens 214 disposed between the NIR LED 126 and the LC film 128 to focus the NIR light emitted by the NIR LED 126. In other embodiments, the NIR LED assembly 132 may not include a lens. In yet other embodiments, the lens 212 may be disposed over the LC film 128.

In addition to the NIR LED assembly 132 described above, there may be other assemblies that can be used to tune NIR light. For example, other assemblies may include an interferometer to filter the NIR light emitted by the NIR LED 126.

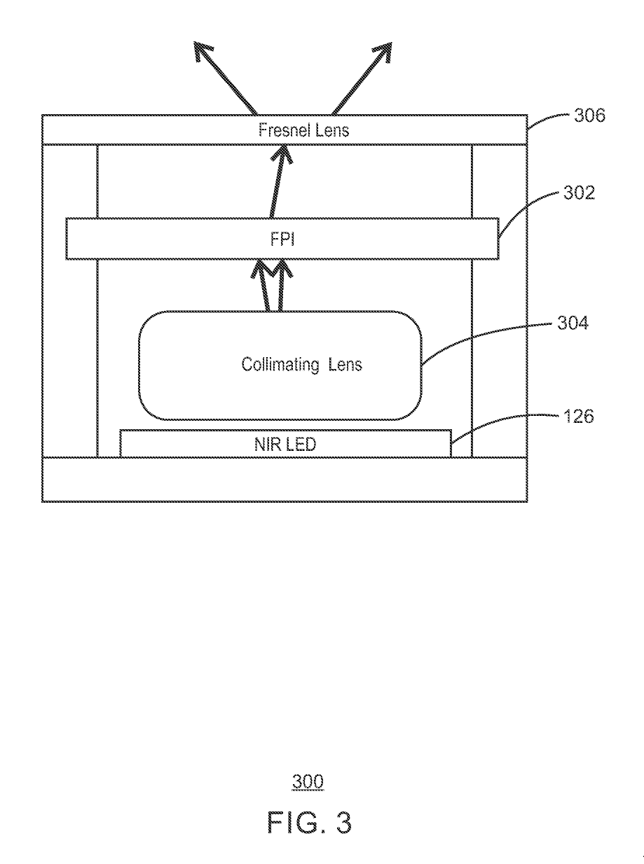

FIG. 3 is an illustration of an assembly 300 that uses an interferometer 302 to tune the NIR light emitted by the NIR LED 126. An example of such an interferometer is the Fabry-Perot interferometer. The Fabry-Perot interferometer includes two reflective mirror surfaces with a gap between them. Examples of the reflective mirror surfaces include thin film Bragg reflectors. The wavelength of light emitted by the NIR LED 126 is tuned by varying the distance between the mirrors.

The interferometer 302 can only accept light that has a maximum incident angle of 5-10°. As a result, a collimating lens 304 may be disposed between the NIR LED 126 and the interferometer 302 to narrow the incident beam of light.

Given the narrow angle of incidence, the light transmitted by the interferometer 302 also has a narrow angle. The narrow angle of transmission may be suitable for iris imaging as only the iris has to fit inside the beam of transmitted light. However, in some embodiments, there may be another lens disposed above the interferometer 302 to widen the angle of the transmitted light. The lens may be a Fresnel lens 306 which is more compact than conventional lenses. The collimating lens 304 may also be in Fresnel form.

Another example of an interferometer that may be used to tune NIR light is the LC polarization interferometer (not to be confused with the LC reflector described above). The LC polarization interferometer takes advantage of the tunable path delay between orthogonal polarization states of an LC material to obtain a very narrow band of NIR light. However, the LC polarization interferometer has the same requirement of a narrow incident beam as do other interferometers. In some embodiments, a collimating lens may be placed between the NIR LED and the LC polarization interferometer. Furthermore, the two polarization components of the LC polarization interferometer each remove 50% of the incident NIR light so that only 25% of the incident beam is ultimately transmitted. As a result, a more intense NIR LED may have to be used.

Whether the NIR light is filtered by a LC reflector or an interferometer, the wavelength of the transmitted light may be in the range 780-860 nm. Within this range, the actual wavelength of NIR light that produces the sharper iris image is determined by the color of the user's iris. A wavelength of 820 nm produces the sharper iris image for the majority of people in the world.

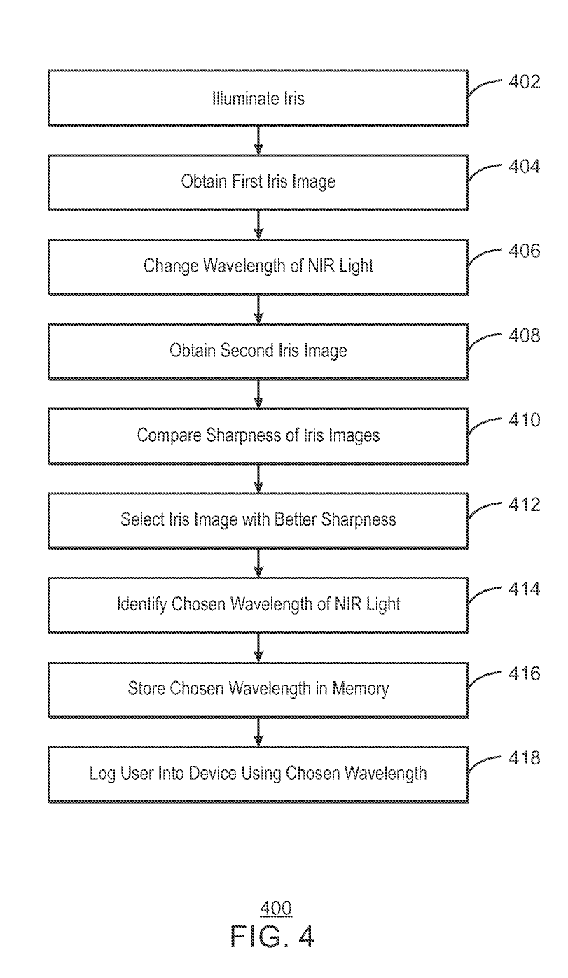

FIG. 4 is a process flow diagram of a method 400 for imaging an iris using an LC reflector. The method 400 may be performed by the electronic device 100 shown in FIG. 1 using the NIR LED assembly 132 shown in FIG. 2.

At block 402, the iris of a user's eye may be illuminated by the NIR LED assembly 132. The wavelength of NIR light that reaches the user's eye is determined by the LC reflector. At block 404, a first iris image may be obtained using the very narrow band of NIR light transmitted by the NIR LED assembly 132. The first iris image may be acquired by the NIR camera 124 of the electronic device 100.

At block 406, the wavelength of the NIR light is changed. If a single LC layer is used, the wavelength of the transmitted NIR light may be changed by altering the excitation frequency and the voltage applied to the layer. In other embodiments that use multiple LC layers, the different layers are activated or deactivated to tune the NIR light emitted by the NIR LED 126.

At block 408, a second iris image may be obtained using the new wavelength of light transmitted by the NIR LED assembly 132. The second iris image may be acquired by the NIR camera 124.

At block 410, the first and second iris images may be compared. In particular, the sharpness of the images may be compared to determine which of the images shows more of the texture of the iris. A sharpness value may be calculated for both the first iris image and the second iris image. The two sharpness values may be compared to determine which of the first and second iris images is sharper.

The sharpness values may be based on the luminance gradients of an iris image. Sharpness may be quantified by approximating the gradient intensity for some or all of the pixels in the focus window of the NIR camera 124. There are various methods for approximating gradient intensity. For example, a common method uses Sobel filters or Laplacian filters. A sharpness value may be obtained by combining the gradient intensities for the whole iris or only some parts of the iris. The simplest method of combination is the calculation of the sum of the gradient intensities. In some embodiments, some parts of the iris may be weighted more than others when summing the gradient intensities. In further embodiments, gradient intensities may be summed for multiple areas of the iris and the sharpness value determined by the area having the largest sum. Sharpness is only one of the metrics that may be quantified to compare the quality of the iris images. In some embodiments, the metric quantified may be the sharpness-to-noise ratio.

Further sharpness may be calculated mostly in an area of interest. For example, the area of interest may be the iris-sclera boundary or the iris-pupil boundary. The sharpness values calculated for these areas represent the contrast of the boundary between the iris and sclera and the boundary between the iris and pupil. Low or insufficient contrast may result in failure to process an iris image.

At block 412, the sharper of the two images may be selected. The sharper image may be the image having the higher sharpness value. At block 414, the wavelength of NIR light used to obtain the selected image may be identified. Blocks 410-414 may be performed by the wavelength identification module 130.

At block 416, the identified wavelength may be stored in memory. At block 418, the user may log into the electronic device 100 by obtaining an iris image using the stored wavelength of NIR light. In this way, the electronic device 100 recognizes the user and allows the user to log into the device. Blocks 402-416 may be performed at enrollment, i.e., the first time a user logs into the electronic device 100. Block 418 may be performed when the user subsequently logs into the device.

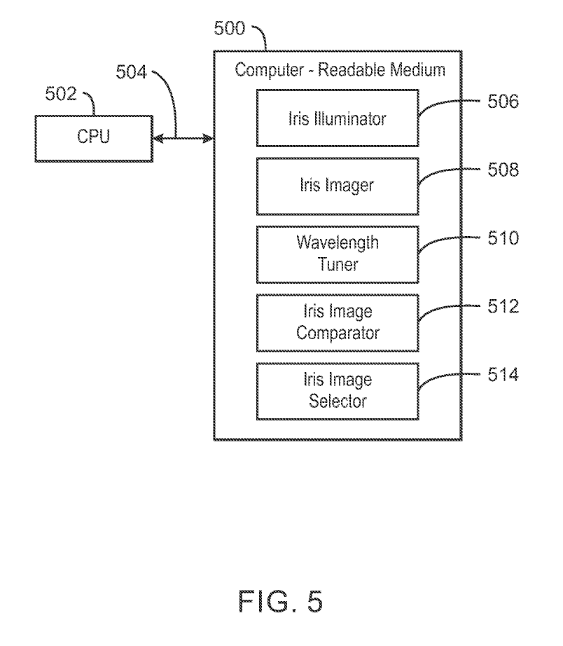

FIG. 5 is a block diagram showing a medium 500 that contains logic for obtaining an iris image using an LC reflector. The medium 500 may be a non-transitory computer-readable medium that stores code that can be accessed by a computer processing unit 502 via a bus 504. For example, the computer-readable medium 500 can be a volatile or non-volatile data storage device. The medium 500 can also be a logic unit, such as an Application Specific Integrated Circuit (ASIC), a Field Programmable Gate Array (FPGA), or an arrangement of logic gates implemented in one or more integrated circuits, for example.

The medium 500 may include modules 506-514 configured to perform the techniques described herein. For example, an iris illuminator 506 may be configured to illuminate a user's iris using a wavelength of NIR light transmitted by a NIR LED assembly 132. An iris imager 508 may be configured to obtain a first image of the user's iris. A wavelength tuner 510 may be configured to change the wavelength of light transmitted by the NIR LED assembly 132. The iris imager 508 may be configured to obtain a second image of the user's iris. An iris image comparator 512 may be configured to compare the first iris image and the second iris image. An iris image selector 514 may be configure to select the sharper of the two images. In some embodiments, the modules 506-514 may be modules of computer code configured to direct the operations of the processor 502.

The block diagram of FIG. 5 is not intended to indicate that the medium 500 is to include all of the components shown in FIG. 5. Further, the medium 500 may include any number of additional components not shown in FIG. 5, depending on the details of the specific implementation.

### EXAMPLES

Example 1 is an electronic device for imaging an iris. The electronic device includes a camera; and a Light Emitting Diode (LED) assembly to provide a light for an iris image. The LED assembly includes an LED; and a tunable filter disposed over the LED, the tunable filter to tune a wavelength of the light emitted by the LED assembly.

Example 2 includes the electronic device of example 1, including or excluding optional features. In this example, the camera is to obtain a first iris image at a first wavelength of the light emitted by the LED assembly and a second iris image at a second wavelength of the light emitted by the LED assembly. Optionally, the electronic device includes a comparing unit to compare a sharpness of the first iris image to the sharpness of the second iris image. Optionally, the electronic device includes a selecting unit to select one of the first iris image and the second iris image to obtain a selected iris image, wherein the selected iris image has a better sharpness. Optionally, the electronic device includes an identifying unit to identify a chosen wavelength of the light by determining the wavelength of light used to obtain the selected iris image.

Example 3 includes the electronic device of any one of examples 1 to 2, including or excluding optional features. In this example, the tunable filter comprises one or more liquid crystal (LC) layers.

Example 4 includes the electronic device of any one of examples 1 to 3, including or excluding optional features. In this example, the tunable filter includes an interferometer. Optionally, the interferometer includes a Fabry-Perot interferometer.

Example 5 includes the electronic device of any one of examples 1 to 4, including or excluding optional features. In this example, the electronic device includes a lens disposed between the LED and the one or more LC layers.

Example 6 includes the electronic device of any one of examples 1 to 5, including or excluding optional features. In this example, the one or more LC layers are disposed between the LED and the lens.

Example 7 includes the electronic device of any one of examples 1 to 6, including or excluding optional features. In this example, a wavelength of the light emitted by the LED is in a range of 780-860 nm.

Example 8 includes the electronic device of any one of examples 1 to 7, including or excluding optional features. In this example, the electronic device includes a proximity sensor to turn off the LED when the electronic device is too close to a user's eye.

Example 9 is a method of capturing an image. The method includes illuminating an iris of a user via a Light Emitting Diode (LED) assembly; obtaining a first iris image from a camera using a first wavelength of a light emitted by the LED assembly; changing a wavelength of the light emitted by the LED assembly; obtaining a second iris image using a second wavelength of the light; comparing a sharpness of the first iris image to the sharpness of the second iris image; and selecting one of the first iris image and the second iris image to obtain a selected iris image, wherein the selected iris image has a better sharpness.

Example 10 includes the method of example 9, including or excluding optional features. In this example, changing a wavelength of the light includes activating one or more liquid crystal (LC) layers.

Example 11 includes the method of any one of examples 9 to 10, including or excluding optional features. In this example, changing a wavelength of the light includes varying a distance between two or more mirrors.

Example 12 includes the method of any one of examples 9 to 11, including or excluding optional features. In this example, the method includes using a lens to focus the light emitted by the LED assembly.

Example 13 includes the method of any one of examples 9 to 12, including or excluding optional features. In this example, the method includes identifying a chosen wavelength of the light by determining the wavelength of light used to obtain the selected iris image. Optionally, the method includes storing the chosen wavelength in memory. Optionally, the method includes logging a user into a device using the chosen wavelength to obtain an iris image.

Example 14 includes the method of any one of examples 9 to 13, including or excluding optional features. In this example, the method includes turning off the LED when the device is too close to a user's eye.

Example 15 is a tangible, non-transitory, computer-readable medium comprising instructions that, when executed by a processor, direct the processor to capture an image. The computer-readable medium includes instructions that direct the processor to illuminate an iris of a user via a Light Emitting Diode (LED) assembly; obtain a first iris image from a camera using a first wavelength of a light emitted by the LED assembly; change a wavelength of the light emitted by the LED assembly; obtain a second iris image using a second wavelength of the light; compare a sharpness of the first iris image to the sharpness of the second iris image; and select one of the first iris image and the second iris image to obtain a selected iris image, wherein the selected iris image has a better sharpness.

Example 16 includes the computer-readable medium of example 15, including or excluding optional features. In this example, the computer-readable medium includes instructions to direct the processor to change a wavelength of the light by activating one or more liquid crystal (LC) layers of an LC film.

Example 17 includes the computer-readable medium of any one of examples 15 to 16, including or excluding optional features. In this example, the computer-readable medium includes instructions to direct the processor to identify a chosen wavelength of the light by determining the wavelength of the light used to obtain the selected iris image. Optionally, the computer-readable medium includes instructions to direct the processor to store the chosen wavelength in memory. Optionally, the computer-readable medium includes instructions to direct the processor to log a user into a device using the chosen wavelength to obtain an iris image.

Example 18 includes the computer-readable medium of any one of examples 15 to 17, including or excluding optional features. In this example, the computer-readable medium includes instructions to direct the processor to turn off the LED when the device is too close to a user's eye.

Example 19 is an apparatus for imaging an iris. The apparatus includes a means for illuminating an iris of a user via a Light Emitting Diode (LED) assembly; a means for obtaining an iris image from a camera using a wavelength of a light emitted by the LED assembly; a means for changing the wavelength of the light emitted by the LED assembly; a means for comparing a sharpness of a first iris image obtained at a first wavelength of the light and the sharpness of a second iris image obtained at a second wavelength of the light, wherein the first iris image and the second iris image are obtained using the means for obtaining an iris image; and a means for selecting one of the first iris image and the second iris image to obtain a selected iris image, wherein the selected iris image has a better sharpness.

Example 20 includes the apparatus of example 19, including or excluding optional features. In this example, the means for changing the wavelength of the light activates one or more liquid crystal (LC) layers.

Example 21 includes the apparatus of any one of examples 19 to 20, including or excluding optional features. In this example, the means for changing the wavelength of the light varies a distance between two or more mirrors.

Example 22 includes the apparatus of any one of examples 19 to 21, including or excluding optional features. In this example, the apparatus includes a means for focusing the light emitted by the LED assembly. Optionally, the means for focusing the light is a lens.

Example 23 includes the apparatus of any one of examples 19 to 22, including or excluding optional features. In this example, the apparatus includes a means for identifying a chosen wavelength of the light by determining the wavelength of light used to obtain the selected iris image. Optionally, the apparatus includes a means for storing the chosen wavelength in memory. Optionally, the apparatus includes a means for logging a user into a device using the chosen wavelength to obtain an iris image.

Example 24 includes the apparatus of any one of examples 19 to 23, including or excluding optional features. In this example, the apparatus includes a means for turning off the LED when the device is too close to a user's eye.

Example 25 is a smart phone capable of imaging an iris for secure log in. The smart phone includes a camera; and a Light Emitting Diode (LED) assembly to provide a light for an iris image; the LED assembly includes an LED; and a tunable filter disposed over the LED, the tunable filter to tune a wavelength of the light emitted by the LED assembly.

Example 26 includes the smart phone of example 25, including or excluding optional features. In this example, the camera is to obtain a first iris image at a first wavelength of the light emitted by the LED assembly.

Example 27 includes the smart phone of any one of examples 25 to 26, including or excluding optional features. In this example, the camera is to obtain a second iris image at a second wavelength of the light emitted by the LED assembly. Optionally, the smart phone includes a comparing unit to compare a sharpness of the first iris image to the sharpness of the second iris image. Optionally, the smart phone includes a selecting unit to select one of the first iris image and the second iris image to obtain a selected iris image, wherein the selected iris image has a better sharpness. Optionally, the smart phone includes an identifying unit to identify a chosen wavelength of the light by determining the wavelength of the light used to obtain the selected iris image.

Example 28 includes the smart phone of any one of examples 25 to 27, including or excluding optional features. In this example, the tunable filter includes one or more liquid crystal (LC) layers. Optionally, the smart phone includes a lens disposed between the LED and the one or more LC layers. Optionally, the one or more LC layers are disposed between the LED and the lens.

Example 29 includes the smart phone of any one of examples 25 to 28, including or excluding optional features. In this example, the tunable filter includes an interferometer. Optionally, the interferometer includes a Fabry-Perot interferometer.

Example 30 includes the smart phone of any one of examples 25 to 29, including or excluding optional features. In this example, a wavelength of the light emitted by the LED is in a range of 780-860 nm.

Example 31 includes the smart phone of any one of examples 25 to 30, including or excluding optional features. In this example, the smart phone includes a proximity sensor to turn off the LED when the smart phone is too close to a user's eye.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the method or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An electronic device for imaging an iris, comprising:
a camera; and
a Light Emitting Diode (LED) assembly to provide a light for an iris image;
the LED assembly comprising:
an LED; and
a tunable filter disposed over the LED, the tunable filter to tune a wavelength of the light emitted by the LED assembly.

2. The electronic device of claim 1, wherein the camera is to obtain a first iris image at a first wavelength of the light emitted by the LED assembly and a second iris image at a second wavelength of the light emitted by the LED assembly.

3. The electronic device of claim 2, comprising a comparing unit to compare a sharpness of the first iris image to the sharpness of the second iris image.

4. The electronic device of claim 3, comprising a selecting unit to select one of the first iris image and the second iris image to obtain a selected iris image, wherein the selected iris image has a better sharpness.

5. The electronic device of claim 4, comprising an identifying unit to identify a chosen wavelength of the light by determining the wavelength of light used to obtain the selected iris image.

6. The electronic device of claim 1, wherein the tunable filter comprises one or more liquid crystal (LC) layers.

7. The electronic device of claim 1, wherein the tunable filter comprises an interferometer.

8. The electronic device of claim 7, wherein the interferometer comprises a Fabry-Perot interferometer.

9. The electronic device of claim 1, comprising a lens disposed between the LED and the one or more LC layers.

10. The electronic device of claim 1, wherein the one or more LC layers are disposed between the LED and the lens.

11. The electronic device of claim 1, wherein a wavelength of the light emitted by the LED is in a range of 780-860 nm.

12. The electronic device of claim 1, comprising a proximity sensor to turn off the LED when the electronic device is too close to a user's eye.

13. A method, comprising:
illuminating an iris of a user via an LED assembly;
obtaining a first iris image from a camera using a first wavelength of a light emitted by the LED assembly;
changing a wavelength of the light emitted by the LED assembly;
obtaining a second iris image using a second wavelength of the light;
comparing a sharpness of the first iris image to the sharpness of the second iris image; and
selecting one of the first iris image and the second iris image to obtain a selected iris image, wherein the selected iris image has a better sharpness.

14. The method of claim 13, wherein changing a wavelength of the light comprises activating one or more LC layers.

15. The method of claim 13, comprising using a lens to focus the light emitted by the LED assembly.

16. The method of claim 13, comprising identifying a chosen wavelength of the light by determining the wavelength of light used to obtain the selected iris image.

17. The method of claim 16, comprising storing the chosen wavelength in memory.

18. The method of claim 17, comprising logging a user into a device using the chosen wavelength to obtain an iris image.

19. The method of claim 13, comprising turning off the LED when the device is too close to a user's eye.

20. A computer-readable medium, comprising instructions to direct a processor to:
illuminate an iris of a user via an LED assembly;
obtain a first iris image from a camera using a first wavelength of a light emitted by the LED assembly;
change a wavelength of the light emitted by the LED assembly;
obtain a second iris image using a second wavelength of the light;
compare a sharpness of the first iris image to the sharpness of the second iris image; and
select one of the first iris image and the second iris image to obtain a selected iris image, wherein the selected iris image has a better sharpness.

21. The computer-readable medium of claim 20, comprising instructions to direct the processor to change a wavelength of the light by activating one or more LC layers of an LC film.

22. The computer-readable medium of claim 20, comprising instructions to direct the processor to identify a chosen wavelength of the light by determining the wavelength of the light used to obtain the selected iris image.

23. The computer-readable medium of claim 22, comprising instructions to direct the processor to store the chosen wavelength in memory.

24. The computer-readable medium of claim 23, comprising instructions to direct the processor to log a user into a device using the chosen wavelength to obtain an iris image.

25. The computer-readable medium of claim 20, comprising instructions to direct the processor to turn off the LED when the device is too close to a user's eye.
